(19) United States
(12) Patent Application Publication
(10) Pub. No.: US 2012/0294129 A1
(43) Pub. Date: Nov. 22, 2012

(54) OPTICAL DISC APPARATUS

(75) Inventor: Tsuyoshi EIZA, Osaka (JP)

(73) Assignee: FUNAI ELECTRIC CO., LTD.

(21) Appl. No.: 13/448,533

(22) Filed: Apr. 17, 2012

(30) Foreign Application Priority Data
May 20, 2011 (JP) 2011-113039

(51) Int. Cl. G11B 7/00

(52) U.S. Cl. 369/44.32; G9B/7

(57) ABSTRACT

An FE·FS ratio, which is a ratio of a focus error signal amplitude and a focus sum signal amplitude which are measured by using one kind of light source of at least two kinds of light sources that are compatible with different kinds of optical discs, is calculated;

it is determined whether the FE·FS ratio is unusual or not by comparing the calculated FE·FS ratio with a threshold value;

a focus servo is turned on in a case where the FE·FS ratio is usual; thereafter, a focus error signal amplitude adjustment value is calculated based on a focus sum signal amplitude measurement value; and

in a case where the FE·FS ratio is unusual, the kind of the light source is changed and a retrial is performed to calculate the FE·FS ratio.

This application is based on Japanese Patent Application No. 2011-113039 filed on May 20, 2011 in Japan, the contents of which are hereby incorporated by reference.

### BACKGROUND OF THE INVENTION

1. Field of the Invention

The present invention relates to an optical disc apparatus.

2. Description of the Related Art

Conventionally, optical disc apparatuses compatible with optical discs such as a Blu-ray disc, a DVD, a CD and the like are variously proposed. These optical disc apparatuses, based on a focus error signal, perform focus servo control, thereby controlling a focal point of a light beam to track a record layer of an optical disc (as an example of a focus control apparatus, see Japanese Patent No. 3436536).

Here, as a conventional optical disc apparatus, there is an optical disc apparatus that adjusts a focus error signal (FE signal) amplitude in a mount procedure of an optical disc; an example of the conventional FE signal amplitude adjustment procedure is shown by a flow chart in FIG. 4.

On starting the flow chart in FIG. 4, first, in a step S1, a determination process is performed to determine whether a mounted optical disc is a Blu-ray disc (BD), a DVD, or a CD. Here, for example, LDs (laser diodes) for the respective discs are successively made to emit light to measure amplitudes of FE signals, whereby the disc is identified based on the measurement results. In the following processes, the LD identified here compatible with the disc is used first.

Next, in a step S2, the FE signal amplitude adjustment is performed. More specifically, an objective lens is moved in a focus direction (direction perpendicular to the record surface of the optical disc), whereby an amplitude of the FE signal is measured and a ratio of the measured value and a target FE signal amplitude is calculated as an FE signal amplitude adjustment value.

And, in a step S3, based on the FE signal amplitude adjustment value calculated in the above step S2, the FE signal is adjusted and focus serve control is turned on. Here, the adjustment of the FE signal based on the FE signal amplitude adjustment value is meant to multiply the FE signal by the FE signal amplitude adjustment value.

Next, in a step S4, based on a focus sum signal amplitude level, the FE signal amplitude adjustment is performed. More specifically, first, the amplitude of the focus sum signal is measured, and a focus sum signal adjustment value (FS adjustment value) is calculated by means of the following formula (1). Here, the focus sum signal is a sum of signals from divided light reception regions of an optical detector in an optical pickup.

The FS adjustment value=the target focus sum signal amplitude/the focus sum signal amplitude measurement value (1)

Then, the FE signal amplitude adjustment value is calculated by means of the following formula (2).

The FE signal amplitude adjustment value=the FS adjustment value×α (α is a fixed value) (2)

And, in a step S5, the FE signal is adjusted based on the FE signal amplitude adjustment value calculated in the above step S4 and it is retried to turn on the focus servo control. If the focus servo control is successfully turned on (Y in a step S6), the procedure ends; however, if it is a failure (N in the step S6), the LD be used is changed and a retrial is performed from the step S2.

In the above conventional FE signal amplitude adjustment procedure shown in FIG. 4, in a case where the optical disc and the LD used are incompatible with each other (e.g., an BD LD for a DVD and the like), a ratio of the FE signal amplitude and the focus sum signal amplitude dramatically deviates from α; accordingly, that FE signal amplitude after the adjustment becomes small. In the step S5, when it is retried to turn on the focus servo control, the objective lens is moved in the focus direction and it is determined whether the FE signal (as generally known, the FE signal draws an S shape) reaches a predetermined level or not; however, the FE signal amplitude is small; accordingly, the predetermined level is undetectable, and it is determined that it is unsuccessfully tried to turn on the focus servo control (N in the step S6). At this time, the objective lens is moved in the focus direction, so that there is a case where the objective lens collides with the optical disc to damage the optical disc.

### SUMMARY OF THE INVENTION

It is an object of the present invention to provide an optical disc apparatus that is able to alleviate an objective lens colliding with and damaging an optical disc during a focus error signal amplitude adjustment.

An optical disc apparatus according to the present invention is structured to include:

at least two kinds of light sources that are compatible with different kinds of optical discs;

an FE·FS ratio calculation portion that calculates an FE·FS ratio which is a ratio of a focus error signal amplitude and a focus sum signal amplitude which are measured by using one kind of light source of the at least two kinds of light sources;

an FE·FS ratio determination portion that compares the calculated FE·FS ratio with a threshold value to determine whether the FE·FS ratio is unusual or not;

a focus servo portion that turns on focus servo control in a case where the FE·FS ratio is usual;

a focus error signal amplitude adjustment portion that calculates a focus error signal amplitude adjustment value based on a focus sum signal amplitude measurement value after the focus servo control is turned on; wherein

in a case where the FE·FS ratio is unusual, the kind of the light source is changed and a retrial by the FE·FS ratio calculation portion is performed.

According to this structure, in a case where the optical disc and the light source used are compatible with each other, the FE·FS ratio becomes usual; accordingly, the focus servo control is turned on and the focus error signal amplitude adjustment is performed. On the other hand, in a case where the optical disc and the light source used are incompatible with each other, the FE·FS ratio becomes unusual; accordingly, the focus servo control is not turned on, the kind of the light source is changed and a retrial is performed. Accordingly, it is possible to alleviate an objective lens colliding with and damaging the optical disc because of turning on the focus servo control.

Besides, the above structure includes a focus servo determination portion that determines whether the focus servo control is successfully turned on or not; in a case where the focus servo control is successfully turned on, the focus error signal amplitude adjustment portion performs calculation, while in a case where the focus servo control is unsuccessfully turned on, the kind of the light source is changed and the retrial by the FE·FS ratio calculation portion may be performed.

Besides, the above structure includes:

a flag set portion that in a case where the FE·FS ratio is determined unusual, makes an FE·FS ratio unusual flag valid, and in a case where the FE·FS ratio is determined usual, makes the FE·FS ratio unusual flag invalid; and

a flag determination portion that determines whether the FE·FS ratio unusual flag is valid or not; wherein

in a case where the FE·FS ratio unusual flag is valid, the retrial may be performed, while in a case where the FE·FS ratio unusual flag is invalid, the focus servo control may be turned on.

Besides, the above structure includes:

an identification portion that identifies the kind of the optical disc; wherein

a light source corresponding to an identification result by the identification portion may be first used.

Besides, in the above structure, the at least two kinds of light sources may be at least three kinds of light sources that are compatible with a Blu-ray disc, a DVD and a CD.

### DESCRIPTION OF THE DRAWINGS

FIG. 1 is a schematic structural view showing a disc player according to an embodiment of the present invention.

FIG. 2 is a schematic view showing an optical system of an optical pickup according to an embodiment of the present invention.

FIG. 3 is a flow chart related to an FE signal amplitude adjustment procedure according to an embodiment of the present invention.

FIG. 4 is a flow chart related to a conventional FE signal amplitude adjustment procedure.

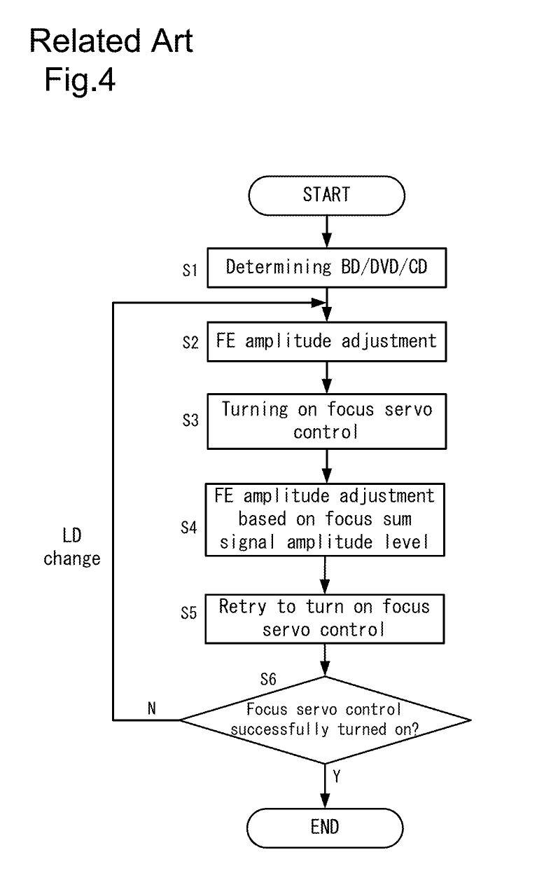

### DESCRIPTION OF THE PREFERRED EMBODIMENTS

Hereinafter, an embodiment of the present invention is described with reference to the drawings.

<Overall Structure>

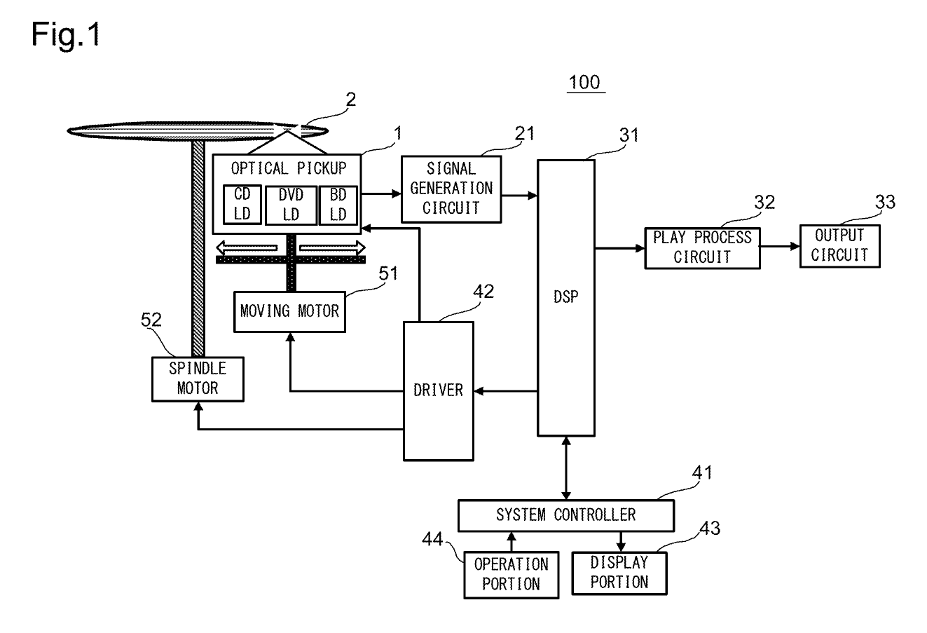

FIG. 1 is a schematic structural view showing a disc player 100 (optical disc apparatus) according to an embodiment of the present invention. The disc player 100 includes: an optical pickup 1; a signal generation circuit 21; a DSP (Digital Signal Processor) 31; a play process circuit 32; an output circuit 33; a system controller 41; a driver 42; a display portion 43; an operation portion 44; a moving motor 51; and a spindle motor 52.

The optical pickup 1 directs a light beam onto an optical disc 2 to read various kinds of information such as sound and voice information, image information and the like recorded on the optical disc 2. This optical pickup 1 is provided with an LD (laser diode) for a CD, an LD for a DVD, and an LD for a BD (Blu-ray disc). Here, details of an inside of the optical pickup 1 are described later.

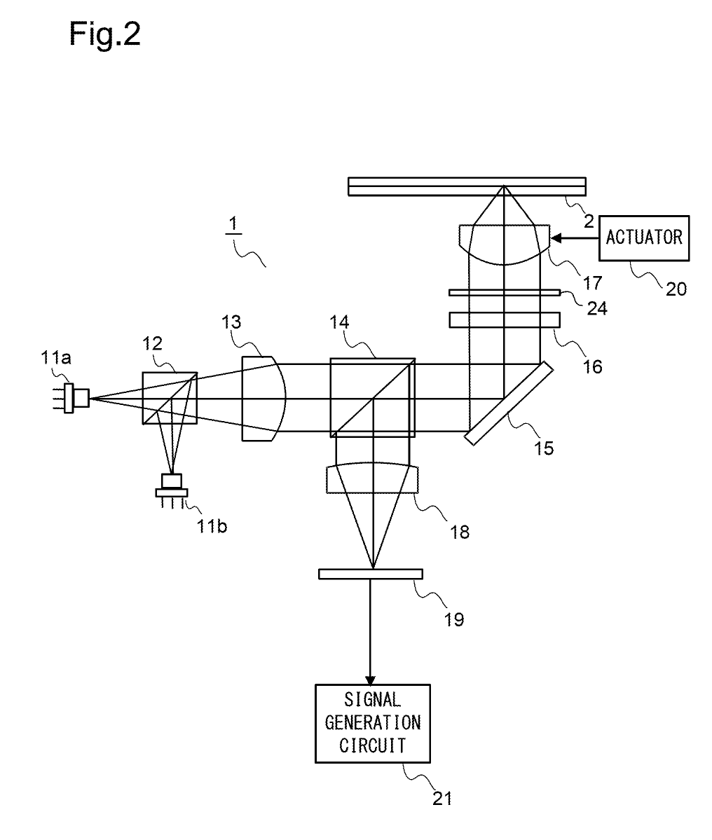

The signal generation circuit 21 performs calculation based on a signal obtained by an optical detector 19 (FIG. 2) of the optical pickup 1 and generates various kinds of signals such as an RF signal, a focus error signal, a tracking error signal, a focus sum signal and the like. And, the signal generation circuit 21 outputs the generated signals to the DSP 31.

The DSP 31 performs an image process based on the RF signal input from the signal generation circuit 21, thereby generating and giving an image signal to the play process circuit 32. The play process circuit 32 performs a D/A conversion process to output the image signal to a not-shown monitor. The signal obtained by the conversion process is output to an external apparatus by the output circuit 33.

Besides, the DSP 31 generates a servo signal based on the focus error signal and the tracing error signal input from the signal generation circuit 21. For example, the DSP 31 generates a tracking servo signal for performing tracking servo control and a focus servo signal for performing focus servo control. The generated servo signals are given to the driver 42. In this way, for example, tracking control, focus control and the like of the objective lens 17 (FIG. 2) of the optical pickup 1 are performed.

The system controller 41 controls operations of the optical pickup 1, the moving motor 51, the spindle motor 52 and the like via the DSP 31. Here, for example, the system controller 41 is achieved by executing a predetermined program on a processing unit such as a plurality of microprocessors or the like. The operation portion 44 has various keys that accept an operation input from a user. The display portion 43 displays various kinds of information such as a play state and the like.

The driver 24 controls driving of the optical pickup 1, the moving motor 51, and the spindle motor 52 based on the servo signal and the like given from the DSP 31. The moving motor 51 drives the optical pickup 1 in a radial direction of the optical disc 2. The spindle motor 52 drives the optical disc 2 in a rotation direction.

<Structure of Optical Pickup>

FIG. 2 is a schematic view showing an optical system of the optical pickup 1 according to the embodiment of the present invention. The optical pickup 1 directs a light beam onto the optical disc 2 to receive reflected light. In this way, the optical pickup 1 reads information recorded on a recording surface of the optical disc 2.

The optical pickup 1 includes: a first light source 11a; a second light source 11b; a dichroic prism 12; a collimate lens 13; a beam splitter 14; a raising mirror 15; a liquid crystal device 16; the objective lens 17; a detection lens 18; the optical detector 19; an actuator 20; and a quarter wave plate 24.

The first light source 11a is an LD that is able to output a light beam of 650 nm corresponding to a DVD and a light beam of 780 nm corresponding to a CD. The second light source 11b is an LD that is able to output a light beam of 405 nm corresponding to a BD. In other words, the first light source 11a is an LD for a DVD and a CD, and the second light source 11b is an LD for a BD.

Here, in the present embodiment, as the first light source 11a, an LD of two-wavelength unitary type, which has two light emitting points that are able to output light beams of two kinds of wavelengths, is used; however, this is not limiting, and for example, an LD, which outputs only a light beam of a single wavelength, may be used.

The dichroic prism 12 transmits the light beam output from the first light source 11a and reflects the light beam output from the second light source 11b. And, the dichroic prism 12 makes the optical axes of light beams output from the first light source 11a and the second light source 11b agree with each other. The light beam transmitted or reflected by the dichroic prism 12 is sent to the collimate lens 13.

The collimate lens 13 converts the light beam output from the dichroic prism 12 into collimated light. The light beam collimated by the collimate lens 13 is sent to the beam splitter 14.

The beam splitter 14 functions as a light separation device for separating the incident light beam, transmits the light beam sent from the collimate lens 13, guides the light beam to the optical disc 2, and reflects the reflected light reflected by the optical disc 2 to guide the reflected light to the optical detector 19. The light beam passing through the beam splitter 14 is sent to the raising mirror 15.

The raising mirror 15 reflects and guides the light beam passing through the beam splitter 14 to the optical disc 2. The raising mirror 15 is inclined by 45° to the optical axis of the light beam from the beam splitter 14, and the optical axis of the light beam reflected by the raising mirror 15 intersects the record surface of the optical disc 2 at substantially right angles. The light beam reflected by the raising mirror 15 is sent to the liquid crystal device 16.

The liquid crystal device 16 is a device that applies a voltage to liquid crystal (not shown) sandwiched by transparent electrodes (not shown), uses a characteristic of liquid crystal molecules for changing the alignment direction to control change in the refractive index, and allows control of a phase of the light beam that passes through the liquid crystal device 16.

By disposing this liquid crystal device 16, it becomes possible to correct spherical aberration that occurs thanks to a difference between resin layers and the like that protect the record surface of the optical disc 2. The light beam passing through the liquid crystal device 16 is sent to the quarter wave plate 24.

The quarter wave plate 24 has a function that converts incident linear polarization light into circular polarization light and converts incident circular polarization light into linear polarization light. The laser light, which is sent from the liquid crystal device 16 and passes through the quarter wave plate 24, is converted from linear polarization light into circular polarization light and is sent to the objective lens 17.

The objective lens 17 concentrates the light beam, which passes through the quarter wave plate 24, onto the record surface of the optical disc 2. Besides, the objective lens 17 is movable by the actuator 20 described later, for example, in an up-down direction (direction perpendicular to the record surface of the optical disc 2) and in a left-right direction (radial direction of the optical disc 2) in FIG. 2, and the position of which is controlled based on the focus servo signal and the tracking servo signal.

The reflected light reflected by the optical disc 2 successively passes through the objective lens 17, the quarter wave plate 24, and the liquid crystal device 16, is reflected by the raising mirror 15, further reflected by the beam splitter 14, and concentrated by the detection lens 18 onto a light reception device that is disposed on the optical detector 19.

The optical detector 19 transduces the light received by means of the light reception device such as a photodiode or the like into an electric signal and outputs the electric signal to the signal generation circuit 21. For example, the optical detector 19 has quarterly divided light reception regions for receiving light beams and is able to perform photoelectric conversion separately for every region and output electric signals.

The actuator 20 moves the objective lens 17 in the radial direction of the optical disc 2 in accordance with an objective lens drive signal that is generated and output by the driver 42 (FIG. 1). For example, the actuator 20 may be an apparatus that is able to flow a drive current into a coil (not shown) situated in a magnetic field that is generated by an permanent magnet (not shown) and drive the objective lens 17 by means of Lorentz's force.

Besides, the actuator 20, in addition to the tracking operation to move the objective lens 17 in a direction along the record surface of the optical disc 2, is able to perform the focus operation as well to make the objective lens 17 come close to and go away from the optical disc 2.

<FE Signal Amplitude Adjustment Procedure>

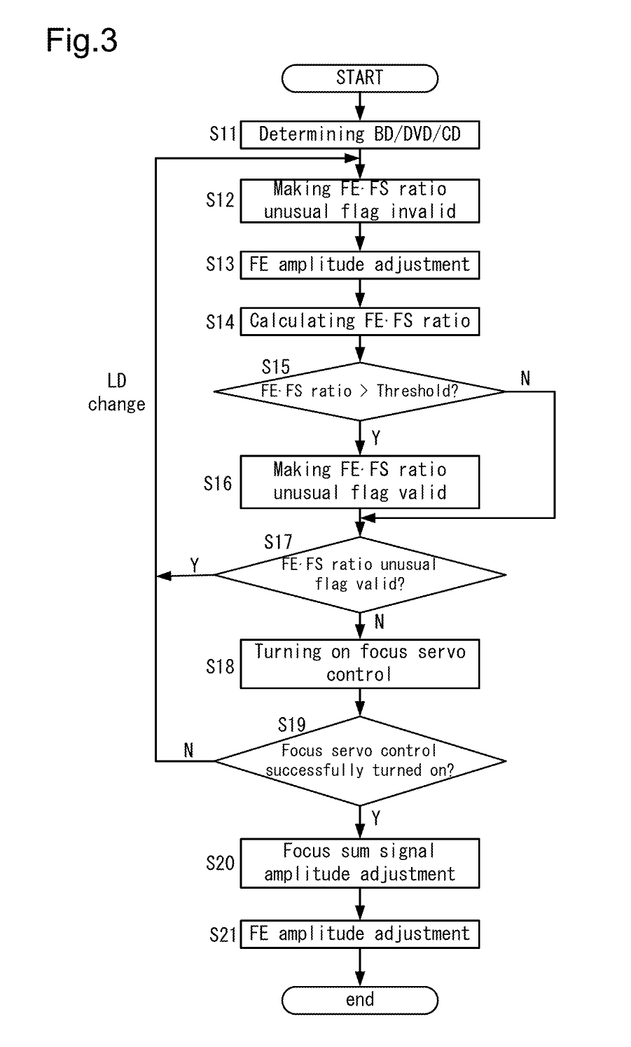

Next, an FE signal amplitude adjustment procedure by the disc player 100 having this structure is described by means of a flow chart in FIG. 3. This procedure is executed in a mount procedure of the optical disc 2.

On starting the flow chart in FIG. 3, first, in a step S11, the system controller 41 determines whether the optical disc 2 is a BD, a DVD, or a CD. Here, for example, the DSP 31 makes successively the LD for a BD, the LD for a DVD, and the LD for a CD emit light and measures FE signal amplitudes; and the system controller 41 determines the kind of the optical disc 2 based on the measurement results. In the following processes, the LD for the kind determined here is used first.

Next, in a step S12, the system controller 41 makes an FE signal amplitude-focus sum signal amplitude ratio unusual flag (hereinafter, called an FE·FS ratio unusual flag) invalid.

And, in a step S13, the system controller 41 performs an FE signal amplitude adjustment. More specifically, the DSP 31 moves the objective lens 17 in the focus direction to measure the amplitude of the FE signal; and the system controller 41 calculates a ratio of the measured value and a target FE signal amplitude as an FE signal amplitude adjustment value. Besides, at this time, the DSP 31 measures the amplitude of the focus sum signal as well. Here, the focus sum signal is a sum signal of signals from the divided light reception regions of the optical detector 19.

Next, in a step S14, the system controller 41 calculates an FE·FS ratio (FS/FE) that is a ratio of the measured FE signal amplitude and the measured focus sum signal amplitude. And, in a step S15, the system controller 41 determines whether the calculated FE·FS ratio is larger than a threshold value or not.

If the calculated FE·FS ratio is larger than the threshold value (Y in the step S15), the process goes to a step S16, where the FE·FS ratio unusual flag is made valid and the process goes to a step S17. On the other hand, in a case where the calculated FE·FS ratio is equal to or smaller than the threshold value (N in the step S15), the process goes to the step S17.

In the step S17, the system controller 41 determines whether the FE·FS ratio unusual flag is valid or not; if it is valid (Y in the step S17), the system controller 41 changes the LD used and performs a retrial from the step S12. On the other hand, in a case where the FE·FS ratio unusual flag is invalid (N in the step S17), the system controller 41 goes to a step S18 to make the DSP 31 turn on the focus servo control in accordance with an instruction. At this time, the system controller 41 adjusts the FE signal based on the FE signal amplitude adjustment value that is calculated in the step S13.

In a step S19 after the step S18, the system controller 41 determines whether the focus servo control is successfully turned on or not. When the focus servo control is turned on and the objective lens 17 is moved in the focus direction, the FE signal substantially surely reaches a predetermined level; however, there is a possibility that the FE signal becomes unstable. If the DSP 31 detects that the FE signal is unstable as described above, the system controller 41 determines that the focus servo control is unsuccessfully turned on (N in the step S19). In this case, the system controller 41 changes the LD used and performs a retrial from the step S12.

On the other hand, in a case where it is determined that the focus servo control is successfully turned on (Y in the step S19), the process goes to a step S20. In the step S20, the system controller 41 calculates a focus sum signal adjustment value (FS adjustment value) by means of the above formula (1). And, in a step S21, the system controller 41 calculates an FE signal amplitude adjustment value by means of the above formula (2). In this way, the procedure ends (END).

Here, in the procedure in FIG. 3, in a case where it is found Y in the step S17 or N in the step S19 even if the LD is changed to use all kinds of the LDs, a retrial is performed beginning with the first LD. And, for example, the procedure is suspended when a predetermined time passes after the procedure in FIG. 3 starts, error display is performed on an OSD (On Screen Display) screen, and further the optical disc 2 may be ejected.

According to this procedure of the present embodiment, in the case where the optical disc and the LED used are incompatible with each other, the FE·FS ratio becomes larger than the threshold value; accordingly, the FE·FS ratio unusual flag becomes valid, the focus servo control is not turned on, the LD is changed and the retrial is performed. In this way, it is possible to alleviate the objective lens 17 colliding with and damaging the optical disc 2 because of turning on the focus servo control.

And, in the case where the optical disc and the LD used are compatible with each other, the FE·FS ratio becomes equal to or smaller than the threshold value; accordingly, the FE·FS ratio unusual flag becomes invalid, the focus servo control is turned on, and the FE signal amplitude adjustment is performed.

Hereinbefore, the embodiment of the present invention is described; however, the embodiment is variously modifiable within the scope of the spirit of the present invention.

For example, in the above embodiment, the three kinds of LDs compatible with the BD/DVD/CD are disposed; however, the present invention is applicable to an optical disc apparatus in which at least two kinds of LDs are disposed. Besides, the optical disc apparatus may be an optical disc apparatus that performs at least either of recording onto and playing an optical disc.

Besides, in the “ratio” in the above embodiment, any value may be used as the denominator.

What is claimed is:

1. An optical disc apparatus comprising:
at least two kinds of light sources that are compatible with different kinds of optical discs;
an FE·FS ratio calculation portion that calculates a an FE·FS ratio which is a ratio of a focus error signal amplitude and a focus sum signal amplitude which are measured by using one kind of light source of the at least two kinds of light sources;
an FE·FS ratio determination portion that compares the calculated FE·FS ratio with a threshold value to determine whether the FE·FS ratio is unusual or not;
a focus servo portion that turns on focus servo control in a case where the FE·FS ratio is usual;
a focus error signal amplitude adjustment portion that calculates a focus error signal amplitude adjustment value based on a focus sum signal amplitude measurement value after the focus servo control is turned on; wherein
in a case where the FE·FS ratio is unusual, the kind of the light source is changed and a retrial by the FE·FS ratio calculation portion is performed.

2. The optical disc apparatus according to claim 1, further comprising
a focus servo determination portion that determines whether the focus servo control is successfully turned on or not; wherein
in a case where the focus servo control is successfully performed, the focus error signal amplitude adjustment portion performs calculation, while in a case where the focus servo control is unsuccessfully turned on, the kind of the light source is changed and the retrial by the FE·FS ratio calculation portion is performed.

3. The optical disc apparatus according to claim 1, further comprising
a flag set portion that in a case where the FE·FS ratio is determined unusual, makes an FE·FS ratio unusual flag valid, and in a case where the FE·FS ratio is determined usual, makes the FE·FS ratio unusual flag invalid; and
a flag determination portion that determines whether the FE·FS ratio unusual flag is valid or not; wherein
in a case where the FE·FS ratio unusual flag is valid, the retrial is performed, while in a case where the FE·FS ratio unusual flag is invalid, the focus servo control is turned on.

4. The optical disc apparatus according to claim 1, further comprising
an identification portion that identifies the kind of the optical disc; wherein
a light source corresponding to an identification result by the identification portion is first used.

5. The optical disc apparatus according to claim 1, wherein
the at least two kinds of light sources mean at least three kinds of light sources that are compatible with a Blu-ray disc, a DVD and a CD.
